(19) United States
(12) Patent Application Publication
(10) Pub. No.: US 2026/0144273 A1
(43) Pub. Date: May 28, 2026

(54) METHOD AND SYSTEM FOR TRANSFORMING ALTERNATIVE SWEETENERS INTO COTTON CANDY FORM

(71) Applicant: Brittany Porter, West Hollywood, CA (US)

(72) Inventor: Brittany Porter, West Hollywood, CA (US)

(21) Appl. No.: 19/278,768

(22) Filed: Jul. 23, 2025

Related U.S. Application Data
(60) Provisional application No. 63/724,393, filed on Nov. 24, 2024.

(51) Int. Cl. A23G 3/38; A23G 3/10; A23G 3/34; A23G 3/36; A23G 3/42

(52) U.S. Cl. CPC A23G 3/38; A23G 3/0051; A23G 3/10; A23G 3/362; A23G 3/42

(57) ABSTRACT

A method and system for transforming alternative sweeteners into spun confectionery products resembling traditional cotton candy is disclosed. The system provides a process for optimizing the melting, spinning, and cooling steps necessary for producing cotton candy from various alternative sweeteners, including but not limited to allulose, erythritol, monk fruit, and synthetic substitutes. The method employs precise temperature control, specialized spinning mechanisms, and innovative cooling systems to ensure product quality. The system features automated parameter adjustment based on sweetener properties and accommodates a wide range of alternative sweeteners with varying physical and chemical characteristics. The system enables the production of sugar-free or low-calorie cotton candy with texture and taste characteristics comparable to traditional sucrose-based products, while incorporating advanced stabilization methods and processing modifications for optimal product consistency.

This patent application claims priority to U.S. Provisional Patent Application Ser. No. 63/724,393 filed on Nov. 24, 2024, which is incorporated herein by reference in its entirety.

### BACKGROUND OF THE SYSTEM

Cotton candy, also known as spun sugar, is a popular confection that has been enjoyed by people of all ages for over a century. It is made by melting sugar and spinning it through tiny holes in a heated centrifuge. The process creates thin strands of sugar that solidify as they cool, forming a fluffy, cloud-like texture. Cotton candy is often dyed with vibrant food coloring and flavored with artificial or natural flavorings to enhance its appeal.

The primary ingredient in cotton candy is granulated sugar, which is nearly pure sucrose. This sucrose is melted at high temperatures to transform it into a liquid state before being spun into fine threads. Sucrose (granulated sugar) melts at a temperature of approximately 186° C. (367° F.). At this temperature, sucrose undergoes a transition from a solid to a liquid state. However, in the process of making cotton candy, the sugar is typically heated slightly above this melting point to facilitate its transformation into a liquid suitable for spinning. The heating process may bring the sugar to temperatures between 170° C. and 200° C. (338° F. to 392° F.) to ensure it remains in a molten state for spinning while avoiding burning or caramelization.

In addition to sugar, cotton candy may contain small amounts of food-grade coloring agents and flavoring compounds, which contribute to its distinctive appearance and taste. While the manufacturing process is relatively simple, it relies on precise temperature control and specialized equipment to achieve the desired texture and consistency.

Despite its widespread popularity, cotton candy is considered an unhealthy snack due to its high sugar content and lack of nutritional value. A single serving of cotton candy can contain up to 30 grams of sugar, which is equivalent to the total daily recommended sugar intake for an adult as advised by some health organizations. Consuming excessive amounts of sugar is associated with numerous adverse health effects, including weight gain, tooth decay, and an increased risk of developing chronic conditions such as type 2 diabetes and heart disease. Moreover, the artificial colorings and flavorings often used in cotton candy production have raised concerns among health advocates regarding their potential effects on health, particularly in children.

Thus, with increasing consumer demand for healthier alternatives and the rising prevalence of dietary restrictions, traditional sucrose-based cotton candy presents limitations for many consumers. The high sugar content and caloric value of sucrose make it unsuitable for health-conscious individuals, diabetics, and those following specific dietary regimens.

Efforts have been made to replace sucrose with alternative sweeteners in cotton candy production to create a healthier version of this popular treat. These alternatives include sugar alcohols, non-nutritive sweeteners, and natural sugars such as stevia or monk fruit extract. While these alternatives aim to reduce caloric content or provide other health benefits, their use in cotton candy manufacturing presents several challenges and disadvantages.

### Sugar Alcohols (e.g., Xylitol, Erythritol):

Disadvantages: Many sugar alcohols have a high melting point, which complicates the spinning process. They also tend to crystallize more readily, resulting in a gritty texture rather than the desired fluffy strands. Additionally, consuming large amounts of sugar alcohols may cause digestive discomfort, such as bloating or diarrhea.

### Non-Nutritive Sweeteners (e.g., Aspartame, Sucralose):

Disadvantages: Non-nutritive sweeteners lack the bulk and structural properties of sucrose, making them unsuitable for spinning into cotton candy without significant modifications to the process. Additionally, they may impart an artificial aftertaste and have limited thermal stability, degrading at the high temperatures required for cotton candy production.

### Natural Sweeteners (e.g., Stevia, Monk Fruit Extract):

Disadvantages: Like non-nutritive sweeteners, natural sweeteners such as stevia and monk fruit extract lack the structural characteristics necessary for cotton candy production. They often require the addition of bulking agents or blending with other ingredients to function properly, which can alter the texture and taste of the final product.

### Alternative Natural Sugars (e.g., Fructose, Coconut Sugar):

Disadvantages: Alternative natural sugars have different melting and caramelization points, which can affect the consistency and quality of the spun sugar. They may also introduce distinct flavors or colors that differ from traditional cotton candy, potentially reducing consumer appeal.

Overall, while alternative sweeteners offer potential benefits, their inherent differences in chemical composition and behavior at high temperatures pose significant obstacles to their use in cotton candy production. These challenges often necessitate complex formulation adjustments, increased manufacturing costs, or compromises in product quality, limiting the widespread adoption of these alternatives.

There exists, therefore, a need for an improved method and system capable of successfully converting alternative sweeteners into cotton candy while maintaining desirable product characteristics.

### SUMMARY

A method and system for transforming alternative sweeteners into spun confectionery products resembling traditional cotton candy is disclosed. The system provides a process for optimizing the melting, spinning, and cooling steps necessary for producing cotton candy from various alternative sweeteners, including but not limited to allulose, erythritol, monk fruit, and synthetic substitutes. The method employs precise temperature control, specialized spinning mechanisms, and innovative cooling systems to ensure product quality. The system features automated parameter adjustment based on sweetener properties and accommodates a wide range of alternative sweeteners with varying physical and chemical characteristics. The system enables the production of sugar-free or low-calorie cotton candy with texture and taste characteristics comparable to traditional sucrose-based products, while incorporating advanced stabilization methods and processing modifications for optimal product consistency. The system accommodates current and future alternative sweeteners through adjustable processing parameters and specialized equipment design, supporting molecular weights from 100 to 1000/mol and melting points between 60° C. and 250° C.

The system addresses the aforementioned challenges by providing a comprehensive method and system for producing cotton candy from alternative sweeteners. The system encompasses both the process and apparatus necessary for successful implementation. In one aspect, the system provides a method for preparing a sweetener mix suitable for spinning, including precise temperature control during melting, optimized spinning parameters, and controlled cooling processes.

In another aspect, the system provides a system capable of accommodating various alternative sweeteners, including but not limited to:
Monosaccharides (e.g., allulose, fructose)
Sugar alcohols (e.g., erythritol, xylitol)
Natural extracts (e.g., monk fruit, stevia)
Synthetic substitutes (e.g., sucralose)
Prebiotic fibers or bulking agents

### Isomalts

The system achieves these objectives through carefully controlled temperature ranges, specialized spinning mechanisms, and innovative cooling systems that collectively enable the production of sugar-free or low-calorie cotton candy with characteristics comparable to traditional products.

### BRIEF DESCRIPTION OF THE DRAWINGS

FIG. 1 illustrates a system architecture in an embodiment.

FIG. 2 is a flowchart illustrating the process stages of the system in an embodiment.

FIG. 3 illustrates the Sweetener Input System in an embodiment.

FIG. 4 illustrates the Heating System in an embodiment.

FIG. 5 illustrates the Temperature Control Unit in an embodiment.

FIG. 6 illustrates the Spinning Assembly in an embodiment.

FIG. 7 illustrates the Cooling System in an embodiment.

FIG. 8 illustrates an airflow system in an embodiment.

FIG. 9 illustrates a collection system in an embodiment.

FIG. 10 illustrates an integrated control system in an embodiment.

### DETAILED DESCRIPTION OF THE SYSTEM

The system will now be described more fully hereinafter with reference to the accompanying drawings, in which embodiments of the system are shown. This system may, however, be embodied in many different forms and should not be construed as limited to the embodiments set forth herein.

### System Architecture Overview

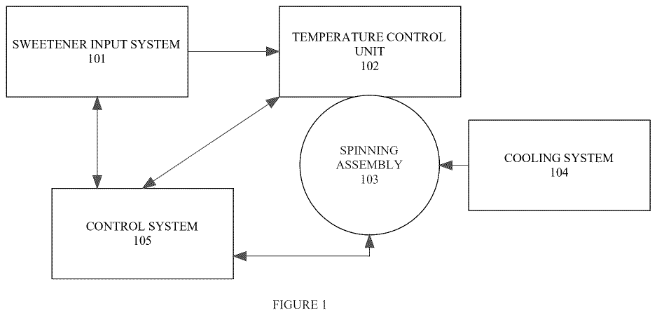

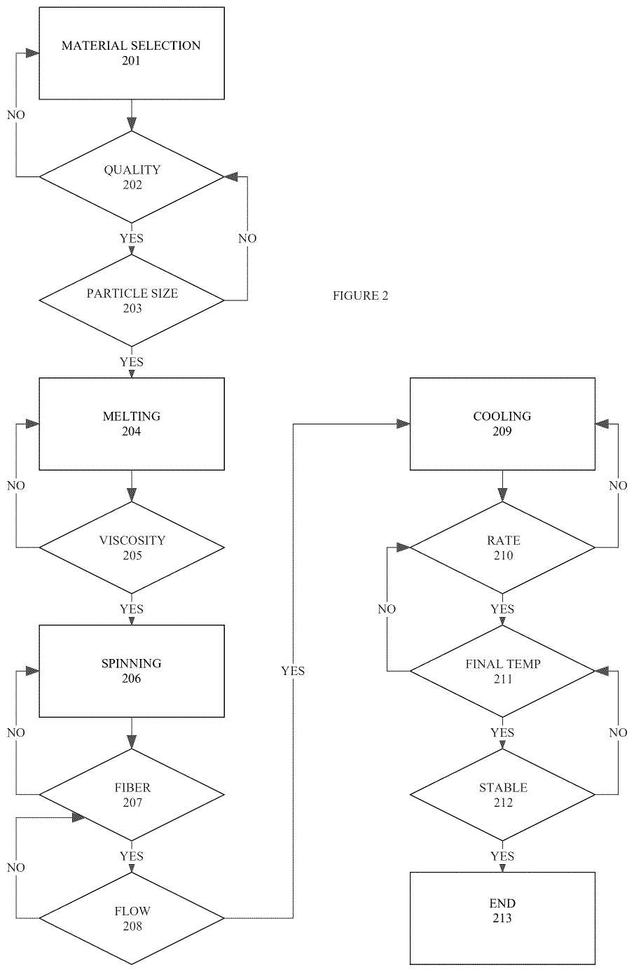

Referring to FIG. 1, in an embodiment, the system comprises a Sweetener Input System 101, Temperature Control Unit 102, Spinning Assembly 103, Cooling System 104, and Control System 105. The operation of the system is described in conjunction with the flow diagram of FIG. 2.

At step 201, the system begins with the preparation of a sweetener mix comprising one or more alternative sweeteners in Sweetener Input System 101. The sweeteners may be used individually or in combinations, optionally including binding agents for enhanced fiber consistency, anti-caking agents to prevent clumping, and/or flavoring or coloring agents for customization. Examples of binding agents include, but are not limited to, maltodextrin, polydextrose, gum Arabic, and modified food starch. Examples of anti-caking agents include, but are not limited to, Silicon Dioxide, Calcium Silicate, and the like.

At decision block 202, the system does a quality check of the ingredients, via Control System 105. The quality check looks for proper composition, moisture content, flow rate, viscosity, and the like. If the quality check is passed, the system proceeds to step 203. If not, the system returns to step 201. At decision block 203, the system checks the particle size of the materials via Control System 105. If the particle size is as desired, for example, between 0.1 to 0.4 mm, the system proceeds to step 204. If not, the system returns to step 202.

Step 204, the melting step, is performed in the Temperature Control Unit 102, managed by Control System 105. The system employs temperature control within specific ranges for different sweetener types. For example, in an embodiment, the following temperature ranges are implemented.
Allulose: 90-110° C.
Monk Fruit: 80-100° C.
Erythritol: 120-150° C.
Xylitol: 92-120° C.
Sucralose: 110-130° C.
Isomalts 145-150° C.

The general temperature range of 80-180° C. accommodates applicable sweeteners while preventing caramelization or degradation.

At step 205, the system checks the viscosity of the melt, to determine if the materials are ready to be spun. In one embodiment, the desired viscosity is in the range of 1 to 500 centipoise. If the melt is not in the desired range, the system returns to step 204. If the melt is within the desired range, the system proceeds to step 206.

The molten sweetener mixture from the Temperature Control Unit 102 is processed through the Spinning Assembly 103 at step 206. In an embodiment, the Spinning Assembly 103 comprises adjustable perforations in the spinner head, variable rotation speeds (e.g., nominal 3500-3600 RPM), and controlled feed rates. The material in the spinner is checked for fiber formation at decision block 207. If fiber is in desired parameters, the system proceeds to step 208, if not, the system returns to step 206. At decision block 208, the material is checked for flow rate. If the flow rate is adequate, the system proceeds to step 209. If not, the system returns to step 207.

The spun fibers are rapidly cooled and stabilized in the Cooling System 104, under the management of Control System 105, at step 209. The system checks the cooling rate at decision block 210. In an embodiment, the cooling rate is approximately 5-10 degrees Centigrade per second. If the rate is acceptable, the system proceeds to step 211. If not, the system returns to step 209.

At decision block 211 it is determined if the material has reached a desired final temperature (e.g. 25-30 degrees Centigrade). If so, the system proceeds to step 212. If not, the system returns to step 210. At decision block 212, it is determined if the material is stable. If so, the system ends at step 213 and the cotton candy is ready. If not, the system returns to step 211.

### Sweetener Input System

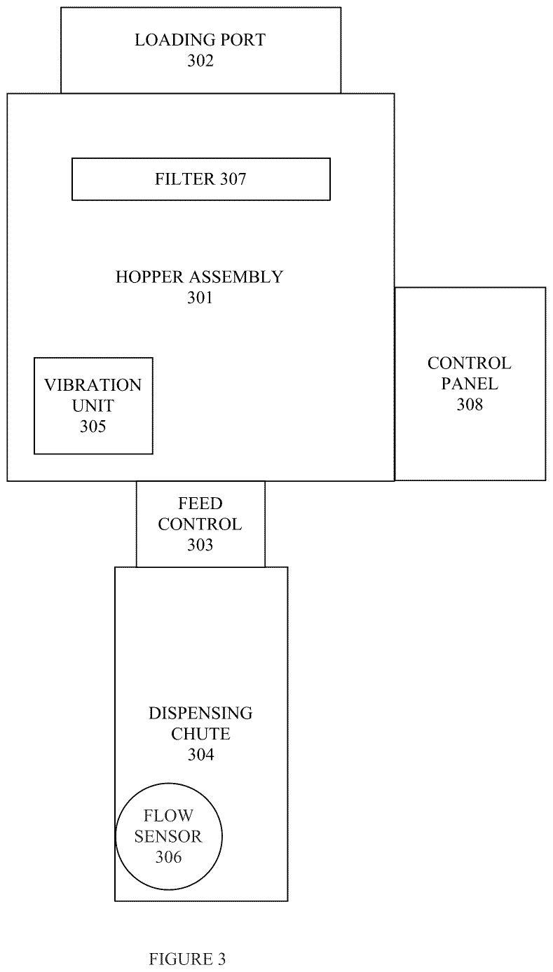

The Sweetener Input System 101 is shown in an embodiment in FIG. 3. The Sweetener Input System comprises a Main Hopper Assembly 301, Loading Port 302, Feed Control Gate 303, Dispensing Chute 304, Vibration Unit 305, Flow Sensor 306, Filter Screen 307, and Control Panel 308.

Material is added into the Loading Port 302 and is sifted by the Filter 307 to fill up Hopper Assembly 301. The Vibration Unit 305 shakes the Hopper 301 allowing the material stored in Hopper 301 to go through Feed Control 303. Feed Control 303 controls the flow rate of the material from Hopper 301 into Dispensing Chute 304. Flow Sensor 306 detects how much material is passing through the Dispensing Chute 304 so that proper amounts are provided to the next stage of the system. The Sweetener Input System 101 is controlled by Control Panel 308.

### Heating System

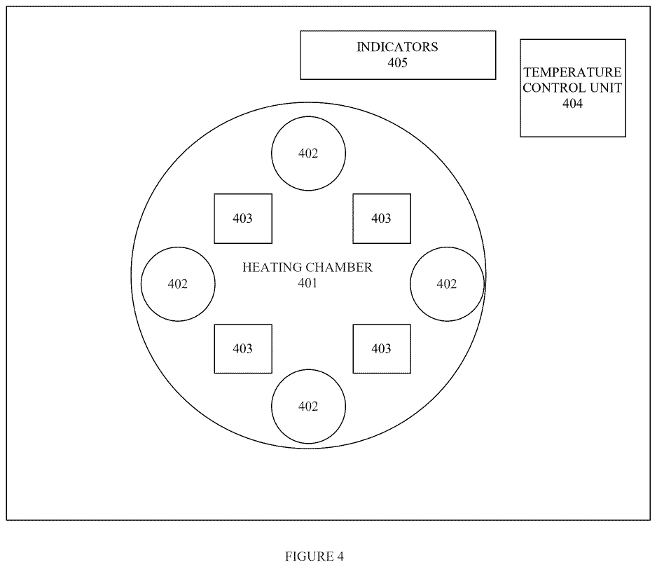

Referring to FIG. 4, the heating system (from box 102 in FIG. 1) comprises, Main Heating Chamber 401, Individual Heating Elements 402, Temperature Sensors 403, Temperature Control Unit 404, and Heat Zone Indicators 405 (Operating Range 80-180° C.). During operation, the Sensors 403 provide data to the Temperature Control Unit 102.

### Temperature Control Unit

Referring to FIG. 5, the Temperature Control Unit 102 features Digital Temperature Display 501, Temperature Range Controls 502, Sensor Input Connections 503, Control Interface with Adjustment 504, and Status Indicators 505.

The temperature control unit maintains precise thermal conditions throughout the process, with operating ranges specific to each sweetener type as detailed in the process section. Sensor Input Connections 503 receive temperature data from the Temperature Sensors 403 of the Heating Chamber 401. The temperature is displayed on Temperature Display 501. The Temperature Range Controls set a high and low value for temperature, depending on the material used in the system. This range is provided to the Temperature Control Unit 404 of the Heating Chamber 401, which maintains the temperature range by controlling the Heating Elements 402. The Status Indicators 505 display the state of the system (e.g. heating, ready, error, and the like).

### Spinning Assembly

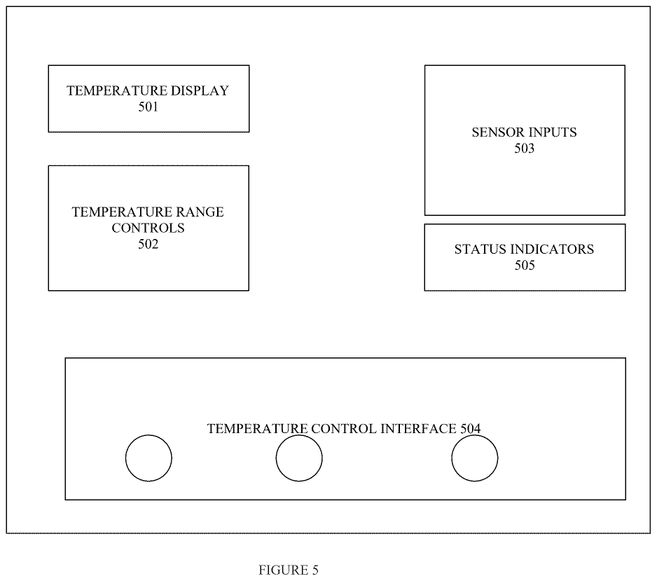

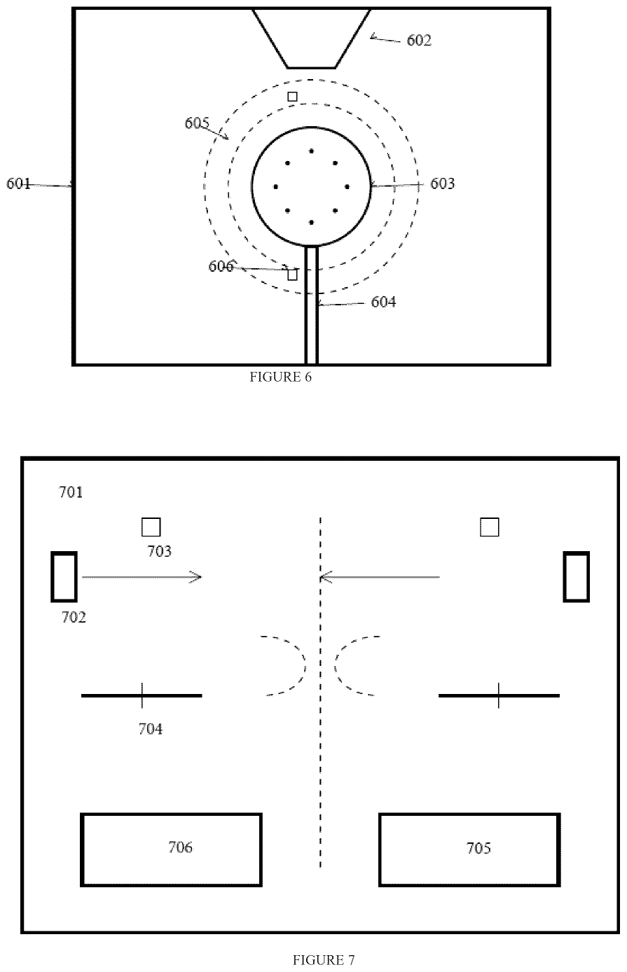

The Spinning Assembly 103 is illustrated in FIG. 6. The Spinning Assembly comprises Main Housing 601, Sweetener Loading Chamber 602, Perforated Spinning Disk 603, Drive Shaft 604, Heating Zones 605, 200-215° C.), and Temperature Sensors 606. ±1° C. accuracy)

In an embodiment, the Spinning Disk 603 is comprised of food grade stainless steel and has a disk diameter of approximately 100 mm. The Housing height is approximately 300 mm. The Drive Shaft 604 in an embodiment spins at approximately 3600 RPM to spin the Disk 603. The system is heated via Heating Zones 605 operating at 200-215 degrees Centigrade Molten material is provided to the Spinner 103 via the Sweetener Loading Chamber 602, where it is spun into fibers.

### Cooling System

The Cooling System 104 is illustrated in FIG. 7 and comprises Main Cooling Chamber 701, Directed Airflow Nozzles 702, Temperature Sensors 703, Airflow Control Dampers 704, Humidity Control Unit 705, and Cooling Rate Control 706.

The cooling system maintains precise temperature reduction at 5-10° C./second to achieve the optimal final temperature of 30° C. while preserving fiber structure.

### Air Flow Assembly

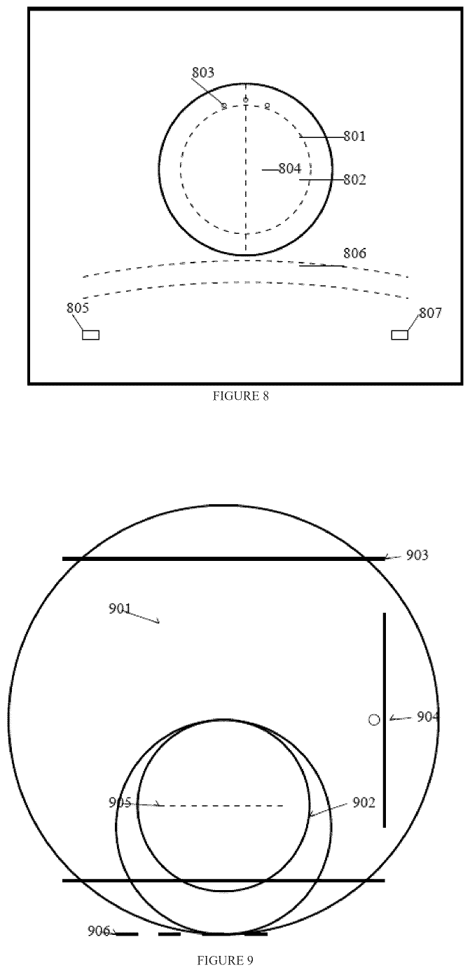

The Air Flow Assembly is illustrated in FIG. 8 and comprises Spinner Head 801, Sweetener Chamber 802, Adjustable Perforations 803, Rotation axis 804, Air Nozzles 805, Airflow pattern 806, and Temperature Control 807.

### Collection System

The Collection System is illustrated in FIG. 9 and comprises Main Collection Chamber 901, Removable Collection Tray 902, Barrier Walls 903, Access Door 904, Collection Surface 905, and Airflow Vents 906.

### Integrated Control System

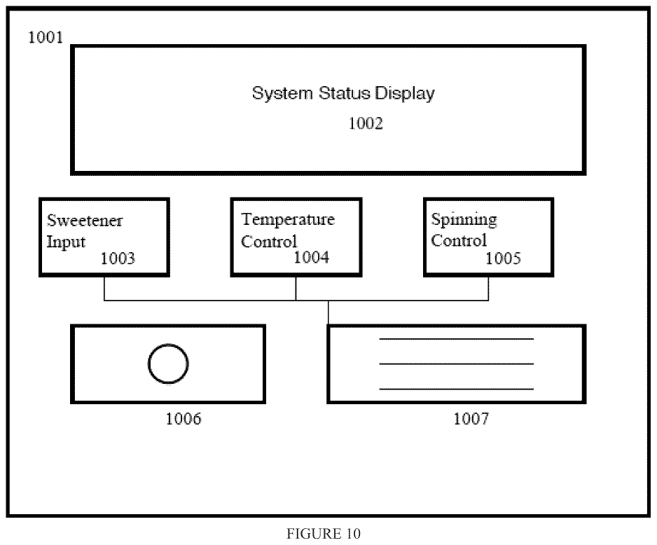

Integrated Control System is illustrated in FIG. 10 and comprises Main Control Console 1001, System Status Display 1002, Sweetener System Interface 1003, Temperature Control Interface 1004, Spinning Control 1005, Emergency Controls 1006, and Process Parameter Input Panel 1007.

### Materials

The system and method accommodate alternative sweeteners with the following characteristics:
Melting point range: 60° C. to 250° C.
Molecular weights: 100 to 1000 g/mol
Crystallization temperatures: 20° C. to 180° C.
Viscosity range: 1.0 to 500 centipoise at processing temperature
Solubility: 0.1 to 200 g/100 mL water at 25° C.
Hygroscopicity: 0% to 95% RH at 25° C.
pH stability range: 2.0 to 10.0

### Alternative Sweetener Categories and Combinations

The system accommodates:
Natural sugar alternatives
Rare sugars (e.g., allulose, tagatose, isomaltulose)
Sugar alcohols (e.g., erythritol, xylitol, maltitol, sorbitol, mannitol)
High-intensity sweeteners (e.g., stevia, monk fruit, thaumatin)
Synthetic sweeteners
Artificial high-intensity sweeteners
Modified natural sweeteners
Novel sweetener compounds
Sweetener blends
Binary combinations
Tertiary combinations
Complex multi-component systems
Bulking agents and carriers
Polysaccharides
Dietary fibers
Protein-based bulking agents
Modified starches

### Processing Parameters Adaptation

The system comprises automatic parameter adjustment based on:
Sweetener thermal properties
Heat capacity: 0.1 to 5.0 J/g·K
Thermal conductivity: 0.05 to 2.0 W/m·K
Thermal diffusivity: 0.05 to 1.5 mm²/s
Physical properties
Density: 0.5 to 2.5 g/cm³
Surface tension: 20 to 100 mN/m
Glass transition temperature: −20° C. to 200° C.

### Stabilization Methods

The system incorporates multiple stabilization approaches:
Environmental control
Humidity range: 20% to 80% RH
Temperature range: 15° C. to 35° C.
Air pressure: 0.8 to 1.2 atm
Structure stabilization
Cross-linking agents
Crystal nucleation promoters
Anti-hygroscopic coatings
Processing modifications
Variable cooling rates: 1° C./s to 10° C./s
Staged temperature reduction
Controlled crystallization

In one embodiment, the system utilizes isomalts as the alternative sweetener. By way of example, the characteristics of the isomalt is a melting point of 145-150° C., a molecular weight of 344.31 grams per mole, a crystallization temperature of 90-95° C., a viscosity range of 40-80 centipoise (at processing temperatures), a solubility of 24-28 grams per 100 ml of water at 25° C., a hygroscopicity of 25-30% at 25° C., and a pH stability range of 4.0 to 9.0.

In an embodiment, the heating profile of isomaltis 3-4° C. per minute to 140° C., then slower heating at 1-2° C. per minute to final temperature. The holding temperature in an embodiment is 170-175° C. for preferred viscosity prior to spinning at a spinner temperature of 200-215° C. A cooling rate of 5° C. per second is applied in an embodiment for preferred structure formation. The resulting material can maintain its fiber structure for 7-14 day under controlled humidity (e.g. 40-50% RH).

Some alternative sweetener combinations include 60% isomalt and 40% allulose (may improve fiber consistency and reduce crystallization), 80% isomalt and 20% erythritol (may enhance cooling sensation), and 75% isomalt, 0.1% Stevia plus 24.9% maltodextrin (may provide more balanced sweetness profile).

Binding agents have been found to work well with gum Arabic and modified food starch at 0.3 to 0.8% concentration. Calcium Silicate has been found to be an effective anti-caking agent at 0.1 to 0.2% concentration.

Thus, a method and apparatus for transforming alternative sweeteners into cotton candy has been described.

What is claimed is:

1. A method A method for producing spun confectionery products using alternative sweeteners, comprising:
preparing a sweetener mix comprising at least one non-sucrose sweetener;
heating said sweetener mix to a temperature between 80° C. and 180° C.; spinning said heated sweetener mix through a perforated spinning head to form fibers; and
cooling said fibers using directed airflow to stabilize their structure.

2. The method of claim 1, wherein said non-sucrose sweetener is selected from the group consisting of: monosaccharides, sugar alcohols, natural extracts, and synthetic sweetener substitutes.

3. The method of claim 1, wherein said spinning step comprises adjusting spinner head perforation sizes based on sweetener viscosity.

4. The method of claim 1, further comprising adding at least one additive selected from the group consisting of: binding agents, anti-caking agents, flavoring agents, and coloring agents.

5. The method of claim 1, wherein said cooling step comprises controlling airflow direction and speed based on sweetener crystallization properties.

6. The method of claim 1, wherein the system automatically adjusts processing parameters based on sweetener thermal properties including heat capacity, thermal conductivity, and thermal diffusivity.

7. The method of claim 1, wherein the sweetener mix comprises combinations of two or more alternative sweeteners selected from the group consisting of: rare sugars, sugar alcohols, high-intensity natural sweeteners, synthetic sweeteners, and bulking agents.

8. The method of claim 1, further comprising applying stabilization methods selected from the group consisting of: environmental control, structure stabilization, and processing modifications.

9. The method of claim 1, wherein the system accommodates sweeteners with melting points between 60° C. and 250° C., molecular weights between 100 and 1000 g/mol, and viscosities between 1.0 and 500 centipoise at processing temperature.

10. A method for automated parameter adjustment in the production of spun confectionery products, comprising:
measuring thermal and physical properties of input sweeteners;
calculating optimal processing parameters based on measured properties;
automatically adjusting system settings including temperature, spinning speed, and cooling rate.

11. The method of claim 10, wherein the measured properties include heat capacity, thermal conductivity, thermal diffusivity, density, surface tension, and glass transition temperature.

12. A system for producing spun confectionery products using alternative sweeteners, comprising:
a heating element configured to melt sweetener mixtures at controlled temperatures; a spinning head with adjustable perforations; a directed airflow mechanism for fiber cooling and stabilization; and temperature control mechanisms throughout the process.
